(19) United States
(12) Patent Application Publication
(10) Pub. No.: US 2010/0320051 A1
(43) Pub. Date: Dec. 23, 2010

(54) WRAP SPRING MECHANISM

(75) Inventor: Meinhard SCHMIDT, KAMMERSTEIN (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/820,551

(22) Filed: Jun. 22, 2010

(30) Foreign Application Priority Data
Jun. 23, 2009 (DE) 10 2009 029 963.7

(51) Int. Cl. F16D 13/12

(52) U.S. Cl. 192/75

(57) ABSTRACT

A wrap spring mechanism, which has a wrap spring and a closer which is rotatable relative to the wrap spring and which has a driver which acts on one end of the wrap spring in order to bring this into positive contact with a friction surface assigned to the wrap spring for blocking the wrap spring mechanism. The wrap spring mechanism has a plurality of coaxial, axially offset wrap springs.

### FIELD OF THE INVENTION

The invention relates to a wrap spring mechanism, comprising a wrap spring and a closer which is rotatable relative to the wrap spring and which has a driver which acts on one end of the wrap spring in order to bring this into positive contact with a friction surface assigned to the wrap spring for blocking the wrap spring mechanism, characterized in that the wrap spring mechanism has a plurality of coaxial, axially offset wrap springs.

### BACKGROUND OF THE INVENTION

Such wrap spring mechanisms are known and serve as a blocking mechanism for blocking an undesired rotary movement of an associated component. Application areas for wrap spring mechanisms are, for example, linear actuators, seat adjusters, windscreen wiper drives, window lifters or level regulators and other applications in motor vehicles.

DE 102 45 620 A1 discloses a blocking mechanism designed as a clamping body blocking device in which, instead of a wrap spring, two clamping bodies are used in order to transmit a torque from an input to an output and to block a torque initiated from the output. The clamping bodies used here are sintered, and therefore the production of such blocking mechanisms is complex. In addition, because of the comparatively large moving masses of the clamping bodies, high speeds of rotation cannot be produced.

A differently designed wrap spring mechanism is known from DE 10 2006 052 200 A1. There, a control wrap spring is used which interacts with a friction surface arranged in the interior of a housing, and, in addition, a second, inner driving wrap spring is provided which is arranged concentrically to the control wrap spring and is coupled thereto.

In conventional wrap spring mechanisms, the problem arises that the surface pressure between the wrap spring and the associated friction surface in the blocked state is high, with the result that undesired material removal occurs in the region of the spring legs. This undesired high wear occurs particularly at rapid switching intervals.

### SUMMARY OF THE INVENTION

The invention is thus based on the object of specifying a wrap spring mechanism which is suitable for rapid switching intervals without excess material wear occurring.

To achieve this object, in a wrap spring mechanism of the type mentioned at the beginning it is provided according to the invention that it has a plurality of coaxial, axially offset wrap springs.

The invention provides that, instead of a single wrap spring, a plurality, in particular two, wrap springs are used which have the same axis of rotation. The two wrap springs are arranged behind one another on the axis of rotation, with the result that the contact surface between the wrap springs and the friction surface is approximately twice the size as in conventional wrap spring mechanisms, thereby correspondingly reducing the surface pressure. This reduced surface pressure results in virtually no significant material removal taking place in the region of the spring legs or on the friction surface, with the result that a long service life and a disruption-free operation are ensured. The basic idea of the invention can be seen in the fact that, through the use of two separate wrap springs, the surfaces which produce the desired friction and effect the blocking are significantly increased, with the result that the discrete stress peaks are considerably reduced. By contrast, other measures, for example the coating of the friction surface or the use of wrap springs with a larger wire cross section, can frequently not be implemented since the installation space required therefor is not available. A further advantage of the solution according to the invention can be seen in the fact that the wrap spring mechanism according to the invention still functions even with the failure of one wrap spring.

The wrap spring mechanism according to the invention is particularly suitable for such applications in which the friction surface is annular. The wrap springs can then be accommodated in a housing, for example a sleeve, with the result that the opening and closing takes place by a rotary movement.

According to an advantageous development of the invention, it may be provided that the or both wrap springs are the same size. Through this measure, the number of parts is advantageously reduced.

According to a development of the invention, it may be provided that a wrap spring has three to five windings. In such a construction, a good blocking action with minimum wear results.

In the wrap spring mechanism according to the invention, a closer is preferably provided which can be set in rotation by an external torque in order to move the wrap springs into a blocking position. Likewise, in the wrap spring mechanism according to the invention, an opener which can be set in rotation by a drive motor may be provided in order to move the wrap springs into an open position.

### BRIEF DESCRIPTION OF THE DRAWING

Further advantages and details of the invention are explained by way of an exemplary embodiment with reference to the drawings. The drawings are schematic illustrations in which:

FIG. 1 shows an exploded view of a wrap spring mechanism according to the invention;

FIG. 2 shows a view of the wrap spring mechanism of FIG. 1 from below;

FIG. 3 shows a sectional side view of the wrap spring mechanism of FIG. 2;

FIG. 4 shows an enlarged view of a detail of the wrap spring mechanism of

FIG. 3 in the region of the wrap springs;

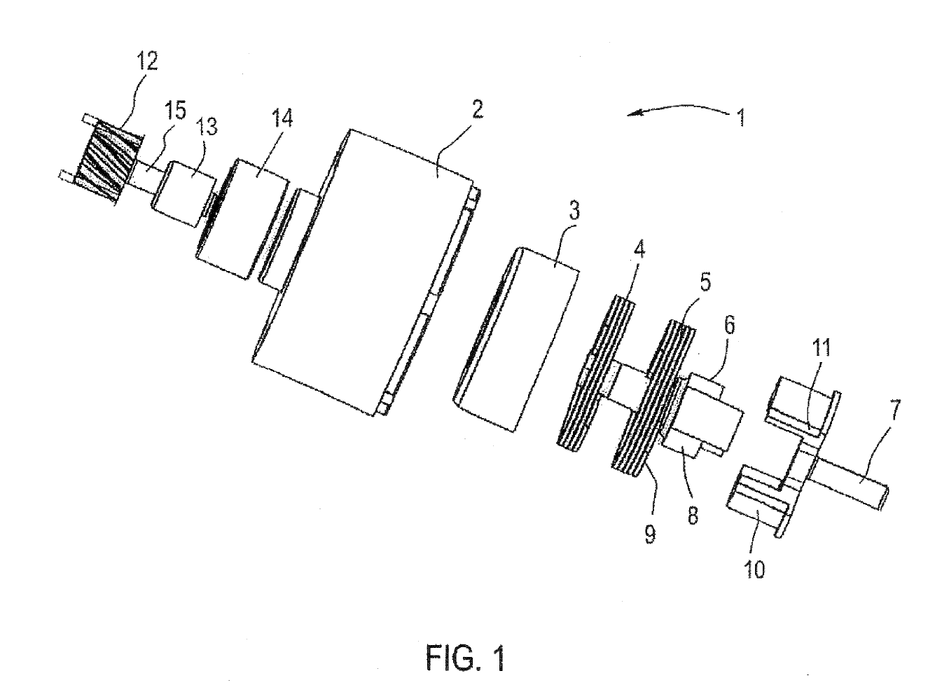

FIG. 5 shows a plan view of the wrap spring mechanism of FIG. 1;

FIG. 6 shows a perspective view of the wrap spring mechanism of FIG. 1; and

FIG. 7 shows an enlarged detail of the wrap spring mechanism of FIG. 6 in the region of the wrap springs.

### DETAILED DESCRIPTION OF THE DRAWING

The wrap spring mechanism 1 shown in an exploded view in FIG. 1 comprises a housing 2 in which a sleeve 3 is fixedly mounted. The sleeve 3 has a friction surface for wrap springs on its inner side. The size of the sleeve is chosen such that a plurality of wrap springs which are axially offset or are arranged next to one another can be accommodated. In the exemplary embodiment represented, the wrap spring mechanism 1 comprises two wrap springs 4, 5. The wrap springs 4, 5 have an annular basic shape and have angled spring leg ends 9. Each wrap spring 4, 5 has three to five windings made of a spring material, preferably of steel.

A further constituent part of the wrap spring mechanism 1 is a closer 6 which in the installed state is arranged centrally within the wrap springs 4, 5. The closer 6 is of hollow design and a shaft 15 is guided through the hollow space in order to drive an opener 7. The closer 6 is provided on its outer side with two mutually opposite radially projecting drivers 8 which can be brought by a surface into contact with a spring leg end 9. The two drivers 8 are offset with respect to one another by 180°.

The opener 7, which serves to unblock the wrap spring mechanism 1, has two mutually opposite circular segment-shaped portions 10 which are each provided on their end faces with an actuating surface 11, which respectively rotate the wrap springs 4, 5 during the rotation of the opener 7. For this purpose, the opener 7 is connected via the shaft 15 to a pinion 12 which is coupled to a drive motor designed as an electric motor. Further constituent parts of the wrap spring mechanism 1 are a bush 13 arranged in the region of the pinion 12 and also a ball bearing 14. By way of this bearing arrangement, a rotation of the closer 6 relative to the sleeve 3 and the housing 2 is made possible.

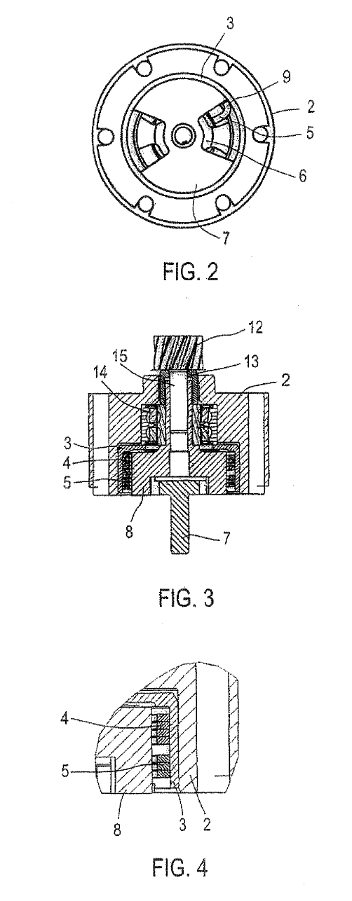

FIG. 2 shows the wrap spring mechanism 1 in a view from below. It can be seen here that the spring leg end 9 of the wrap spring 5 bears on the inner side of the sleeve 3, which acts as a friction surface.

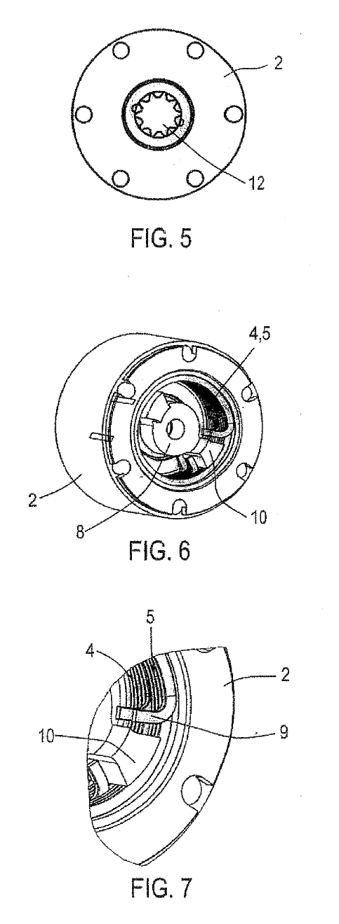

FIG. 3 shows a sectional side view of the wrap spring mechanism 1, and FIG. 4 shows an enlarged view of a detail of the wrap spring mechanism of FIG. 3 in the region of the wrap springs. In this view it can be seen that the pinion 12 is connected via the shaft 15 to the opener 7, with the result that the opener 7 is set in rotation during a rotation of the pinion 12. By means of the ball bearing 14, the closer 8 is movable with respect to the housing 2 and the sleeve 3 connected fixedly to the housing 2. As can best be seen in FIG. 4, the two wrap springs 4, 5 are situated in the annular space formed between the driver 8 and the sleeve 3. With respect to their axis of rotation, the wrap springs 4, 5 are arranged behind one another, axially offset. FIG. 5 shows the wrap spring mechanism 1 in a plan view.

The function of the wrap spring mechanism 1 is explained below. The closer 6 can be set in rotation by an external torque; this torque is also referred to as a misuse load. Through the rotation of the closer 6 the latter contacts the spring leg ends 9 of the two closing springs 4, 5 and rotates them. As a result, the wrap springs 4, 5 attempt to deflect outwardly and in so doing move on the friction surface. The movement of the wrap springs 4, 5 is limited by the inner side of the sleeve 3, with the result that a further rotary movement of the closer 6, and hence of the wrap springs 4, 5, is braked and then stopped, with the result that the wrap spring mechanism 1 is situated in a blocked state. To open or unblock the wrap spring mechanism 1, the opener 7 is rotated by an electric drive motor via the pinion 12 and the shaft 15 in the opposite direction to the preceding movement of the closer 6, with the result that the actuating surface 11 of the circular segment-shaped portion 10 of the opener 7 acts on the spring leg ends 9 and rotates the wrap springs 4, 5. Here, the wrap springs 4, 5 move radially inwardly, with the result that they no longer bear on the inner side of the sleeve 3, thereby opening the wrap spring mechanism 1.

Since two coaxial, axially offset wrap springs 4, 5 are provided in the wrap spring mechanism, the surface pressure between the spring leg ends 9 of the wrap springs 4, 5 and the inner surface of the sleeve 3 during closing or blocking is considerably reduced, with the result that material removal on the spring leg ends 9 or on the inner side of the sleeve 3 is avoided.

The perspective view of FIGS. 6 and 7 shows particularly clearly the spring leg ends 9 of the two wrap springs 4, 5 and the portion 10 of the opener 7.

### LIST OF REFERENCE NUMBERS

1 Wrap spring mechanism
2 Housing
3 Sleeve
4 Wrap spring
5 Wrap spring
6 Closer
7 Opener
8 Driver
9 Spring leg end
10 Portion
11 Actuating surface
12 Pinion
13 Bush
14 Ball bearing
15 Shaft

1. A wrap spring mechanism, comprising:
a wrap spring; and
a closer which is rotatable relative to the wrap spring and which has a driver which acts on one end of the wrap spring in order to bring this into positive contact with a friction surface assigned to the wrap spring for blocking the wrap spring mechanism,
wherein the wrap spring mechanism as a plurality of coaxial, axially offset wrap springs.

2. The wrap spring mechanism of claim 1, wherein the wrap spring mechanism has two coaxial, axially offset wrap springs.

3. The wrap spring mechanism of claim wherein the friction surface is annular.

4. The wrap spring mechanism of claim 1, wherein the wrap springs are accommodated in an interior of a sleeve.

5. The wrap spring mechanism of claim 4, wherein the friction surface is formed on an inner side of the sleeve.

6. The wrap spring mechanism of the claim 1, wherein the or both wrap springs are the same size.

7. The wrap spring mechanism of claims 1, wherein a wrap spring has three to five windings.

8. The wrap spring mechanism of claim 1, wherein a closer is provided which can be set in rotation by an external torque in order to move the or both wrap springs into a blocking position.

9. The wrap spring mechanism of claim 1, wherein the opener, which can be set in rotation by a drive motor, is provided in order to move the or both wrap springs into an open position.
